(19) United States
(12) Patent Application Publication
(10) Pub. No.: US 2024/0188747 A1
(43) Pub. Date: Jun. 13, 2024

(54) JOG DIAL AND INDICATOR LIGHT FOR JUICER

(71) Applicant: I-TECH USA, INC., Farmington Hills, MI (US)

(72) Inventor: Sung Hyun Kim, Jeju-si (KR)

(21) Appl. No.: 18/538,039

(22) Filed: Dec. 13, 2023

Related U.S. Application Data
(60) Provisional application No. 63/432,313, filed on Dec. 13, 2022.

(51) Int. Cl. A47J 19/02; G06F 3/0362; G06F 3/0488

(52) U.S. Cl. CPC A47J 19/02; G06F 3/0362; G06F 3/0488

(57) ABSTRACT

The present disclosure provides a juicer. The juicer can include a juicer body, a jog dial, and an indicator. The juicer body can include a face plate having an outer perimeter. The jog dial can be rotatably disposed on the face plate. The indicator can be disposed along a portion of the outer perimeter and can be configured to display a juicer status.

### CROSS-REFERENCE TO RELATED APPLICATIONS

This application claims the benefit of U.S. Provisional Application No. 63/432,313, filed on Dec. 13, 2022. The entire disclosure of the above application is incorporated herein by reference.

### FIELD

The present technology relates to a dial and indicator, and more specifically, a jog dial and indicator light for a juicer.

### INTRODUCTION

This section provides background information related to the present disclosure which is not necessarily prior art.

Juicers are kitchen appliances designed for extracting juice from various fruits and vegetables and provide a convenient and nutritious way to incorporate fresh produce into one's diet. Juicers have gained widespread popularity due to their ability to create fresh and flavorful juices in a matter of minutes. Juicers come in various types, each with its own unique features and advantages.

Juicers are available in a wide range of designs and features, offering options for every budget and dietary preference. Whether users are seeking a quick morning boost of energy or aiming for a healthier lifestyle by incorporating fresh juices into their diet, juicers provide a versatile and convenient means to enjoy the benefits of freshly squeezed juice. Jog dials have become increasingly popular in the design of modern juicers, enhancing user experience and functionality. Jog dials offer a convenient and intuitive way to operate juicing machines, allowing users to finely tune the juicing process and customize their juice extraction to their preferences.

Jog dials include circular knobs that users can rotate to adjust various settings on a juicer. They provide a tactile and precise means of control, offering several advantages for juicer operation. Jog dials allow users to adjust settings such as juicing speed, pulp extraction, and juice thickness with precision. By turning the dial clockwise or counterclockwise, users can easily make incremental changes to their juicing parameters.

Indicator lights have also become a standard feature in modern juicers, serving as a visual communication tool to convey essential information to users during the juicing process. Indicator lights can include various LED or light emitting components. Various indicator lights can play a role in enhancing the functionality and operability of juicers and can provide a means to readily identify the status of a juicer.

While jog dials and indicator lights offer several advantages in terms of intuitive control and customization, they are not without their drawbacks. Most indicators are small and lack a substantial surface area of the juicer that would permit the user to see the indicator light. Additionally, most indicators lack the ability to customize color, light intensity, and brightness limiting the possible indicators for the user and requiring the user to memorize factory-set indicators.

Accordingly, there is a need for a juicer with a means for customizing the juicing process and an indicator light to provide the user with updates during the juicing process.

### SUMMARY

In concordance with the instant disclosure, a juicer with a means for customizing the juicing process and an indicator light to provide the user with updates during the juicing process, has surprisingly been discovered.

The present technology includes articles of manufacture, systems, and processes that relate to juicers. In certain embodiments, the present disclosure provides a juicer. The juicer can include a juicer body, a jog dial, and an indicator. The juicer body can include a face plate. The face plate can include an outer perimeter. The face plate can extend outwardly from the juicer body and can include a curvature. The jog dial can be disposed on the face plate and can extend outwardly from the face plate. The jog dial can be configured to rotate by the user to select a juicing setting. The jog dial can include a substantially circular cross section and a user interface. The indicator can be disposed along a portion of the outer perimeter of the face plate and can be configured to display a juicer status. The indicator can include a customizable indicator light configured to display at least one of an indicator light color, an indicator light pattern, and an indicator light brightness.

The present disclosure further provides a method for customizing the indicator. The method can include a step of providing the juicer of the present disclosure including the jog dial and the indicator. The method can include a step of selecting an indicator modifying setting on the juicer. The method can further include a step of rotating the jog dial to select an indicator attribute, such as light color, light brightness, or light pattern, as non-limiting examples. The method can include a step of selecting the indicator attribute as desired by the user such that the indicator attribute is set.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of a hopper coupled to a juicer having a juicer outlet, pulp outlet, handle and juicer body including an indicator light and a jog dial;

FIG. 2 is a front elevational view of the juicer body an attachment means for the hopper, according to one embodiment of the present disclosure;

FIG. 3 is a side elevational view thereof;

FIG. 4 is a front elevational view of the juicer body, according to a second embodiment of the present disclosure;

FIG. 5 is a front elevational view of a portion of the hopper and the juicer body in a stop mode;

FIG. 6 is a front elevational view of a portion of the hopper and the juicer body in a start mode;

FIG. 7 is a front elevational view of a portion of the hopper and the juicer body depicting a visualization element for modifying the indicator;

FIG. 8 is a front elevational view of a portion of the hopper and the juicer body depicting a visualization element for selecting a recipe;

FIG. 9 is a front elevational view of a portion of the hopper and the juicer body depicting a visualization element for modifying the indicator; and

FIG. 10 is a method for customizing the indicator of the juicer.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

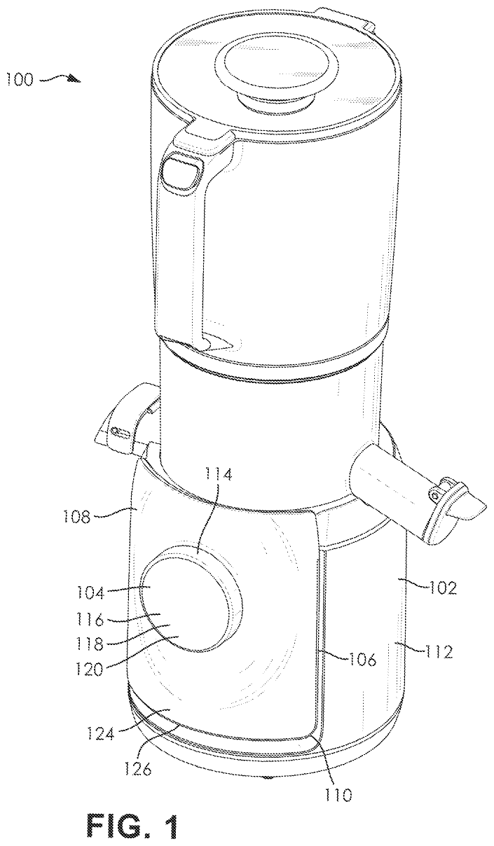

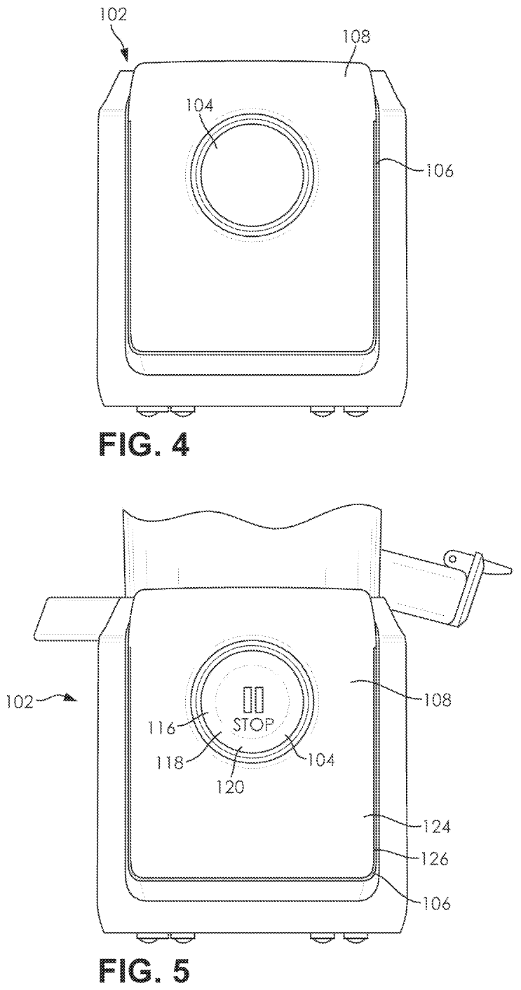

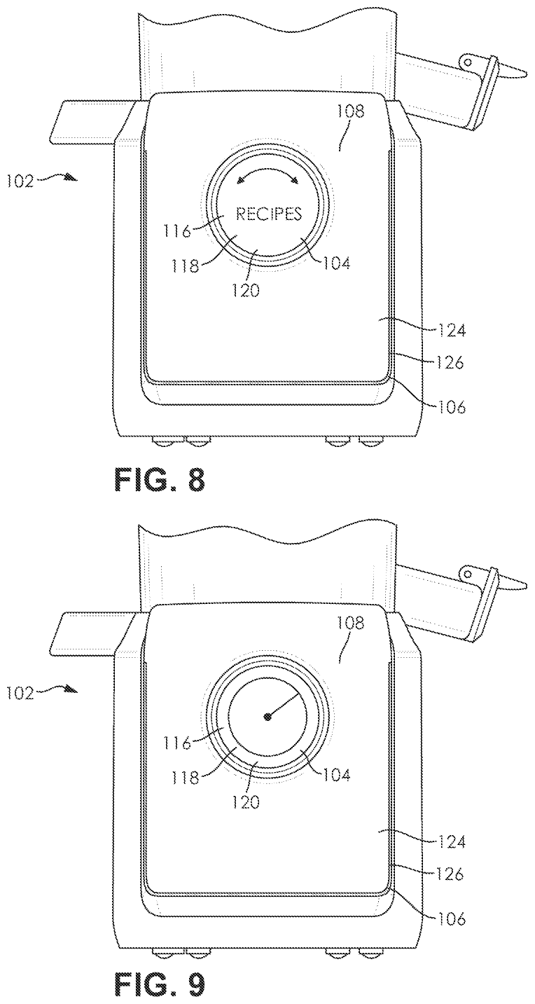

The present disclosure provides a juicer 100 for user by a user to juice foods, shown generally in FIGS. 1-9. Certain aspects of the juicer 100 can allow for easy navigation of all of the features of the juicer 100. Further, the juicer 100 can provide the user with quick visual updates of the status of the juicer 100 during operation and the juicing process as well while the juicer 100 is not in use. As shown in FIG. 1, the juicer 100 can include a juicer body 102, a jog dial 104, and an indicator 106. The juicer body 102 can include a face plate 108. The face plate 108 can include an outer perimeter 110. The jog dial 104 can be rotatably disposed on the face plate 108. The indicator 106 can be disposed along a portion of the outer perimeter 110 of the face plate 108 and can be configured to display a juicer status.

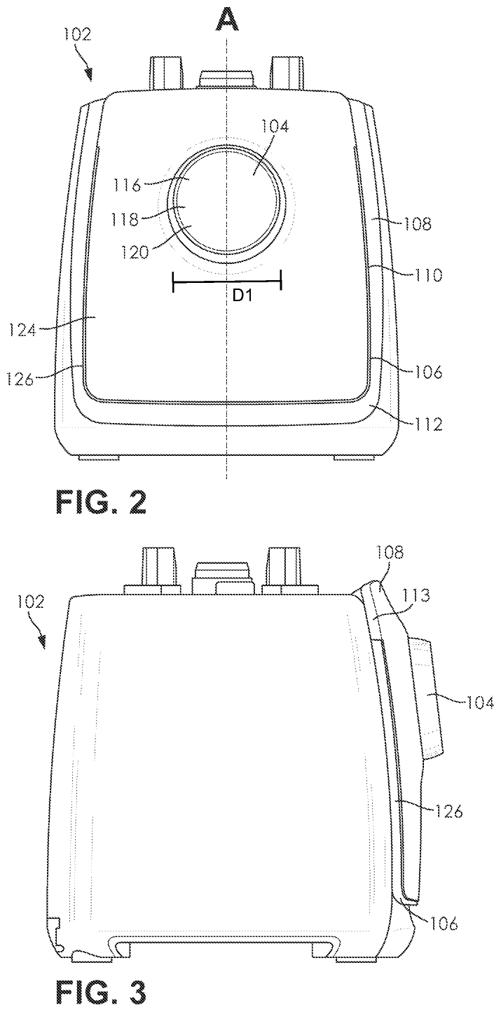

As shown in FIGS. 1 and 4-5, the juicer body 102 can have a substantially circular cross section and be generally cylindrical in shape. Alternatively, the juicer body 102 can have a substantially rectangular cross section and be generally cuboid, as shown in FIGS. 2-3. Additionally, the juicer body 102 can be sized to allow for the juicer 100 to be placed on a household counter for household use. As a non-limiting example, the juicer body 102 can include a height and width of less than one foot to allow for the juicer body to be stored on a countertop under an upper cabinet or within a cabinet. A skilled artisan can select a suitable shape and size for the juicer body 102 within the scope of the present disclosure. The juicer body 102 can be preferably formed of a rigid material, such as an opaque plastic material, to allow for the inner mechanical parts of the juicer to be hidden from the user. Further, the juicer body 102 is preferably formed of a non-porous material to allow for easy clean up by the user after using the juicer 100 to juice or blend food and the militate against food or liquid from entering the juicer body 102 and impacting the mechanical function of the juicer 100. A skilled artisan can select a suitable material for the juicer body 102 within the scope of the present disclosure.

FIG. 1 also depicts additional parts of the juicer 100 such as a hopper, a juice outlet, and a pulp outlet. The hopper, the juice outlet, and the pulp outlet can be configured to be powered by the juicer body 102 and a motor disposed within the juicer body 102. A portion of the hopper, the juice outlet, and the pulp outlet are also shown in FIGS. 5-9.

With reference to FIG. 3, the face plate 108 can be disposed adjacent to the juicer body 102 and can extend outwardly from a surface 112 of the juicer body 102. Where the juicer body 102 is substantially cylindrical, as shown in FIGS. 1 and 4-9, the face plate 108 can also include a curvature that substantially corresponds to the curvature of the juicer body 102. Alternatively, where the juicer body 102 is substantially cuboid with a slight curvature, as shown in FIGS. 2-3, the face plate 108 can be substantially planar or include a slight curvature to conform with the contour of the juicer body 102. In this way, the face plate 108 can be shaped and curved to correspond with the shape and curvature of the juicer body 102. A skilled artisan can select a suitable curvature for the juicer body 102 and the face plate 108 within the scope of the present disclosure. It should be noted that the face plate 108 can extend outwardly from the surface 112 of the juicer body 102 to create an edge 113, as shown in FIG. 3.

With continued reference to FIG. 3, the jog dial 104 can extend outwardly from the surface 112 of the juicer body 102 and the face plate 108. As a non-limiting example, the jog dial 104 can include a substantially circular cross section and can be ergonomically shaped to allow for the user to easily grip the jog dial 104 with their fingers. The jog dial 104 can be a substantially disc shaped and can be rotatably disposed on a central axis A of the face plate 108, as shown in FIG. 2. The jog dial 104 can have a diameter DI, also shown in FIG. 2. As a non-limiting example, the diameter DI can be between about one half of an inch and about three inches. As stated above, the diameter DI can allow for the jog dial 104 to be grasped by the user and promote easy navigation of the features of the juicer 100. A skilled artisan can select a suitable diameter DI for the jog dial 104 within the scope of the present disclosure.

As shown in FIG. 3, an exterior surface 114 of the jog dial 104 can be smooth to allow for fluid, uninterrupted movement of the user's hand while rotating the jog dial 104. Alternatively, a portion of the exterior surface 114 of the jog dial 104 can be textured and include, for example ridges, bumps, or a patterned surface. As a non-limiting example, the ridges can correspond to a number of options that can be displayed around a perimeter of the jog dial 104 such as a number that corresponds to the speed or intensity at which the juicer 100 operates or a number that corresponds to the length of time the juicer 100 operates for each use. A skilled can select a suitable number of ridges for the jog dial 104 within the scope of the present disclosure.

As shown in FIGS. 1-2, jog dial 104 can be the only user-manipulatable portion of the juicer 100, such that no other user interface component controls the operation of the juicer or the transitions between different juicing modes of operation used by the juicer 100. The jog dial 104 can be configured to assist the user in operating the juicer 100 by allowing the user to select as well as cycle through various juicer settings and features, as well as powering the juicer 100 on and off. The jog dial 104 can also allow the user to check for recipes or juicing programs from a pre-loaded recipe book. The jog dial 104 can further allow the user to select a juicing speed, blending type, and blending time. Alternatively, the juicer body 102 can include other user-manipulatable portions, such as buttons or switches, to modify juicer settings.

With continued reference to FIGS. 1 and 5-9, the jog dial 104 can include a visualization element 116. The visualization element 116 can present the user with options for operating the juicer 100. As a non-limiting example, the visualization element 116 can be printed on the juicer body 102 or the perimeter of the jog dial 104 and display operational functions such as on/off, juicing speed, and juicing time. More particularly, and shown in FIGS. 5-9, the visualization element 116 can be a display in which the user can use the jog dial 104 to select as well as cycle through options available for juicer 100 operation.

With further reference to FIGS. 5-9, the visualization element 116 can include a user interface display 118. The jog dial 104 can be configured to allow the user to interact with the user interface display 118 such that when the user rotates the jog dial 104, they are able to scroll through various displays or settings shown on the user interface display 118. The user interface display 118 can include one or more of a lens, a glass top, an optical element, and/or other components. The user interface display 118 can be flat (e.g., level) and include a curved lens. The user interface display 118 can protrude out from the jog dial 104 or, alternatively, and as shown in FIG. 3, the user interface display 118 can be flush with the jog dial 104.

It should be appreciated that the user interface display 118 can be configured to receive user input and can be configured as a touchscreen. As used herein, user input of the user interface display 118 can include one or more of tapping the user interface display 118, multiple consecutive occurrences of tapping on user interface display 118, swiping the user interface display 118 (e.g., horizontally, vertically, and/or diagonally), rotating the jog dial 104, pressing the jog dial 104, and/or other user gestures, such as a circular swipe or gesture or user interactions with the user interface display 118. In certain embodiments, the user interface display 118 can include a touchscreen 120 configured to receive user input. Where the user interface display 118 includes a touchscreen 120, user input of the user interface display 118 can include one or more of tapping the touchscreen 120, multiple consecutive occurrences of tapping on the touchscreen 120, swiping the touchscreen 120 (e.g., horizontally, vertically, and/or diagonally), and/or other user gestures, such as a circular swipe or gesture or user interactions with the touchscreen 120.

As described above, the jog dial 104 can include various buttons, switches, and the like in addition to the jog dial 104 so that a user may control the electronic device using the user interface display 118. The jog dial 104 can be configured to be depressed to allow the jog dial 104 to act as a button. In this way, the user can actuate the jog dial 104 to select an operating mode or feature displayed on the user interface display 118. It should be appreciated that as the jog dial 104 is rotated by the user and the position of the jog dial 104 is changed, the juicer 100 can detect and recognize the position of the jog dial 104. Accordingly, when the jog dial 104 is rotated, the position of the jog dial 104 is detected, and the juicer 100 recognizes the position of the jog dial 104 to be detected at this time and relays the change to the user interface display 118 and/or begins or ceases operation of the juicer 100.

In certain instances, the jog dial 104 can control the powering on and off of the juicer 100. The jog dial 104, acting as a power button, can be configured to be engaged manually by the user, for example by pushing the jog dial 104 to turn juicer 100 on and off. Alternatively, the power button can be part of the user interface display 118 in which the user can utilize the touchscreen 120 to turn the juicer 110 on or off. A skilled artisan can select a suitable means for powering on and off the juicer 100 within the scope of the present disclosure.

As shown in FIGS. 3 and 5-9, the juicer 100 can include the indicator 106 disposed along a portion of the outer perimeter 110 of the face plate 108. The indicator 106 can be configured to display a juicer status or juicing update. As described above, the face plate 108 can extend outwardly from the surface 112 of the juicer body 102 and form the edge 113. The indicator 106 can be disposed along a portion of the edge 113 as well as a portion of the outer perimeter 110 of a primary surface 124 of the face plate 108, as shown in FIGS. 2-3. Advantageously, this can allow for more surface area for the indicator 106 and can promote visibility of the indicator 106 by the user and others in the household.

With reference to FIGS. 3 and 5-9, the indicator 106 can include an indicator light 126. One or more rows of indicator lights 126 can disposed along a portion of the edge 113 of the face plate 108 and the outer perimeter 110 of the primary surface 124 of the face plate 108. The indicator light 126 can be individual bulbs or, as shown in FIG. 3, can be a light strip. As a non-limiting example, the light strip can include an LED light strip. Alternatively, the indicator lights 126 can also be fiberoptic filaments. The indicator light 126 can be electrically connected to control circuitry, such that a change in illumination pattern, brightness, color, and/or light temperature can be controlled by the user. By way of example, the lights can illuminate in a solid, unbroken pattern when the blender is on but not in use; and can blink, illuminate in patterns, or illuminate in a different color when the blender is in use. Different colors or patterns can be associated with each mode of operation, as described herein. Advantageously, these indicators can make it easy for persons away from the juicer 100 to determine if the appliance is in operation. People within the household can quickly recognize whether the juicer 100 has been left on and unattended, and then turn the juicer 100 off and can militate against unnecessary power usage.

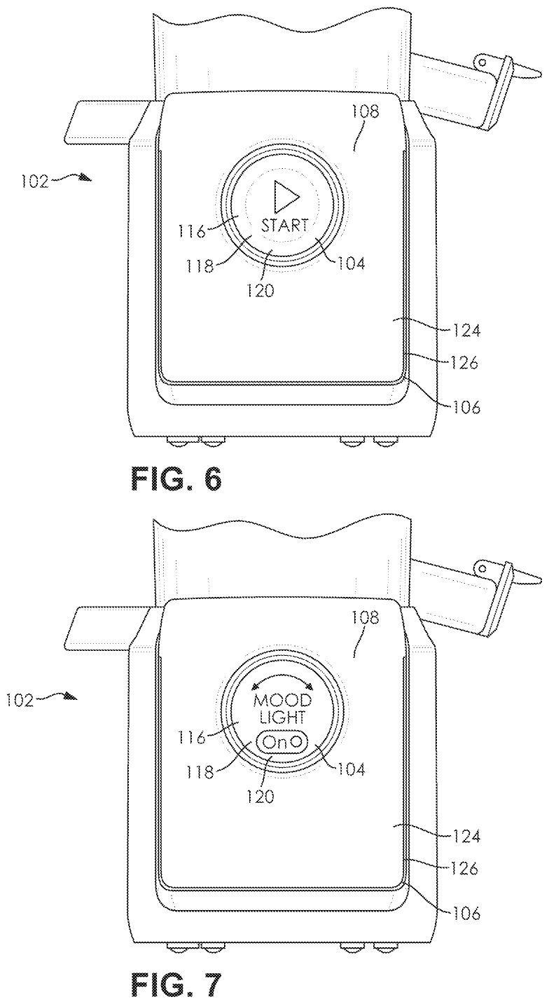

As a non-limiting example, the indicator light 126 can be red, for example, if there is an error with the juicer 100 or if the juicer 100 has been stopped by the user, as shown in FIG. 5. As a further example, the indicator light 126 can be blue, for example, when the juicer is operating, or green, for example, when the juicer 100 is waiting for instructions from the user or when a juicing cycle is complete, as shown in FIG. 6. Advantageously, the various colors of the indicator light 126 can provide the user with status updates that are visible from a greater distance during the juicing process. One of ordinary skill in the art can select other suitable color-coded updates within the scope of the present disclosure.

It should be noted that the user can further customize the indicator light 126, as shown in FIGS. 7 and 9, such that the indicator light 126 includes a default indicator. As a non-limiting example, the user can select a resting color for the default indicator, as shown in FIG. 9. Advantageously, the ability to customize the color of the indicator light 126 can give the user freedom in selecting a color, brightness, and pattern that matches their kitchen scheme or décor. One of ordinary skill in the art can select other suitable light properties that can be adjusted by the user within the scope of the present disclosure.

It should be noted that control circuitry can be configured to control different functions and/or operations of juicer, including but limited to turning the juicer 100 on and off, charging of a rechargeable battery, controlling of an electrical motor regarding and/or during rotation of one or more blades or augers, controlling operation of the indicator light 126, and/or performing other functions for the juicer 100. In some embodiments, the control circuitry can be configured to prevent rotation the one or more blades or augers responsive to a determination that the juicer body or a juicer hopper is not properly installed with respect to the juicer 100. The control circuitry can also be configured to control the indicator light 126 to convey information regarding the operational status of the juicer 100 to the user, as described above. The control circuitry can be implemented as a printed circuit board (PCB) as an example. A skilled artisan can select a suitable control circuitry within the scope of the present disclosure.

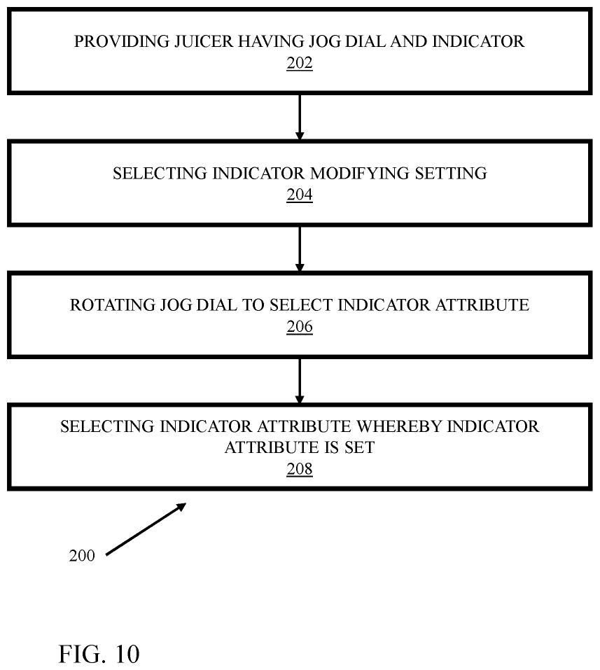

The present disclosure further includes a method 200 for customizing the indicator 106, as shown in FIG. 10. The method 200 can include a step 202 of providing the juicer 100 of the present disclosure including the jog dial 104 and the indicator 106. The method 200 can include a step 204 of selecting an indicator modifying setting on the juicer 100. The method 200 can further includes a step 206 of rotating the jog dial 104 to select an indicator attribute, such as light color, light brightness, or light pattern, as non-limiting examples. The method 200 can include a step 208 of selecting the indicator attribute as desired by the user such that the indicator attribute is set. The user can select the indicator attribute by using the visualization element 116 or depressing the jog dial 104 like a button, as described herein.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A juicer for a user comprising:
a juicer body including a face plate having an outer perimeter;
a jog dial rotatably disposed on the face plate; and
an indicator disposed along a portion of the outer perimeter of the juicer body, the indicator configured to display a juicer status.

2. The juicer of claim 1, wherein the jog dial extends outwardly from the face plate.

3. The juicer of claim 1, wherein the jog dial has a substantially circular cross section.

4. The juicer of claim 1, wherein the jog dial includes a plurality of ridges.

5. The juicer of claim 1, wherein the jog dial includes a diameter between half of an inch and 3 inches.

6. The juicer of claim 1, wherein the jog dial includes a user interface display.

7. The juicer of claim 6, wherein the user interface display includes a touch screen.

8. The juicer of claim 6, wherein the jog dial is configured to allow the user to interact with the user interface display.

9. The juicer of claim 1, wherein the jog dial includes a visualization element disposed on the jog dial.

10. The juicer of claim 1, wherein the jog dial is configured to allow the user to select a recipe from a preloaded recipe book.

11. The juicer of claim 1, wherein the indicator includes an indicator light.

12. The juicer of claim 11, wherein the jog dial is configured to allow the user to customize the indicator light.

13. The juicer of claim 1, wherein the juicer status is conveyed using an indicator light color.

14. The juicer of claim 1, wherein the juicer status is conveyed using an indicator light pattern.

15. The juicer of claim 1, wherein the juicer status is conveyed using an indicator light brightness.

16. The juicer of claim 1, wherein the face plate extends outwardly from the juicer body.

17. The juicer of claim 1, wherein the face plate includes a curvature corresponding to a curvature of the juicer body.

18. The juicer of claim 1, wherein the jog dial is disposed on a central axis of the face plate.

19. A juicer for a user comprising:
a juicer body including a face plate having an outer perimeter and extending outwardly from the juicer body, the face plate including a curvature;
a jog dial disposed on the face plate and extending outwardly from the face plate, the jog dial configured to rotate for the user to select a juicing setting, the jog dial including a substantially circular cross section and a user interface display; and
an indicator disposed along a portion of the outer perimeter and configured to display a juicer status, the indicator including a customizable indicator light configured to display at least one of an indicator light color, an indicator light pattern, and an indicator light brightness.

20. A method for customizing a indicator of a juicer, comprising:
providing a juicer having:
a juicer body including a face plate having an outer perimeter,
a jog dial rotatably disposed on the face plate, and
an indicator disposed along a portion of the outer perimeter of the juicer body, the indicator configured to display a juicer status;
selecting an indicator modifying setting on the juicer;
rotating the jog dial to select an indicator attribute;
selecting the indicator attribute.
